(19) United States
(12) Patent Application Publication
(10) Pub. No.: US 2022/0316101 A1
(43) Pub. Date: Oct. 6, 2022

(54) METHOD FOR MANUFACTURING SPUN YARN MADE OF CARBON NANOTUBES AND SPUN YARN MADE OF CARBON NANOTUBES

(71) Applicants: TOYOTA JIDOSHA KABUSHIKI KAISHA, Toyota-shi (JP); National University Corporation Okayama University, Okayama-shi (JP)

(72) Inventors: Akira KUNITOMO, Nagahama-shi (JP); Kazuhiko TAKAHASHI, Toyota-shi (JP); Yasuhiko HAYASHI, Okayama-shi (JP); Hirotaka INOUE, Okayama-shi (JP); Kensuke UEHARA, Okayama-shi (JP)

(73) Assignees: TOYOTA JIDOSHA KABUSHIKI KAISHA, Toyota-shi (JP); National University Corporation Okayama University, Okayama-shi (JP)

(21) Appl. No.: 17/657,552

(22) Filed: Mar. 31, 2022

(30) Foreign Application Priority Data
Apr. 2, 2021 (JP) 2021-063529
Mar. 22, 2022 (JP) 2022-045006

(51) Int. Cl. D02G 3/02

(52) U.S. Cl. CPC D02G 3/02; D10B 2101/122; B82Y 30/00

(57) ABSTRACT

One aspect of the present disclosure relates to a method for manufacturing a spun yarn made of carbon nanotubes. The method includes: a spun yarn precursor α production step of producing a spun yarn precursor α by pulling a plurality of carbon nanotubes from a carbon nanotube forest and spinning the carbon nanotubes while applying a tension of 6 mN or less per centimeter of a width of the carbon nanotube forest to the carbon nanotubes; a spun yarn precursor β production step of producing a spun yarn precursor β by applying a higher tension than in the spun yarn precursor α production step to the spun yarn precursor α to densify the spun yarn precursor α; and a spun yarn production step of producing the spun yarn by electrically heating the spun yarn precursor β while applying a tension to the spun yarn precursor β.

### CROSS-REFERENCE TO RELATED APPLICATION

This application claims priority to Japanese Patent Application No. 2021-063529 filed on Apr. 2, 2021 and Japanese Patent Application No. 2022-045006 filed on Mar. 22, 2022, each incorporated herein by reference in its entirety.

### BACKGROUND

### 1. Technical Field

The present disclosure relates to manufacturing methods of a spun yarn made of carbon nanotubes and spun yarns made of carbon nanotubes.

### 2. Description of Related Art

Carbon nanotubes (hereinafter also referred to as “CNTs”) have high mechanical strength, thermal conductivity, and electrical conductivity. A plurality of CNTs can be spun to produce a spun yarn made of CNTs (hereinafter also referred to as “CNT spun yarn”). Since CNT spun yarns also have high mechanical strength, thermal conductivity, and electrical conductivity, CNT spun yarns are currently developed as a material for various products.

For example, Y. Song et al., Nanoscale 11,13909-13916 (2019) describes that by performing electrical heating at 2450° C. for 12 milliseconds (voltage pulse width) under a tension of 60 mN, the strength of obtained CNT spun yarns is improved to a breaking stress of 3.2 GPa and a Young's modulus of 123 GPa.

Japanese Patent No. 6667848 (JP 6667848 B) describes a manufacturing method of a structure spun from a spinning source member including a CNT forest. An opening substrate for the CNT forest has a tubular shape, and the entire end of the CNT forest that is located on the open portion side of the opening substrate is a spinnable portion. The manufacturing method includes a spinning step of pulling the CNTs from the spinnable portion and spinning them. The structure manufactured by this method is a tubular web-like structure including a plurality of entangled carbon nanotubes and has an inner surface and an outer surface.

### SUMMARY

As described above, methods for producing a CNT spun yarn have been developed. For example, a CNT spun yarn obtained by spinning a plurality of CNTs pulled from a CNT forest usually has a density of about 0.7 g/cm³ because it is spun by the Van der Waals force between CNT bundles. However, the CNT spun yarn with this density may not have sufficient strength. It is known that densification by applying a tension and a structural change from amorphous carbon to graphene by heating are effective in improving the strength of CNT spun yarns. However, the CNT spun yarn with the above density cannot withstand the tension and breaks when the electrical heating temperature and the tension to be applied are increased. On the other hand, when the electrical heating is performed for an extremely short time in order to avoid breakage of the CNT spun yarn, the breakage of the CNT spun yarn can be avoided, but the structural change from amorphous carbon to graphene is insufficient and the strength of the CNT spun yarn is not sufficiently improved.

The present disclosure provides means for producing a high strength CNT spun yarn.

The inventors found that the electrical heating temperature and the tension to be applied can be increased as compared to the methods of the related art by preliminarily applying, before electrically heating a CNT spun yarn, a high tension within such a range that the CNT spun yarn does not break to densify the CNT spun yarn. The inventors found that a CNT spun yarn produced by the above procedure has high crystallinity and high strength.

That is, the present disclosure includes the following aspects and embodiment.
(1) A method for manufacturing a spun yarn made of carbon nanotubes, the method including: a spun yarn precursor α production step of producing a spun yarn precursor α by pulling a plurality of carbon nanotubes from a carbon nanotube forest and spinning the carbon nanotubes while applying a tension of 6 mN or less per centimeter of a width of the carbon nanotube forest to the carbon nanotubes; a spun yarn precursor β production step of producing a spun yarn precursor β by applying a higher tension than in the spun yarn precursor α production step to the spun yarn precursor α to densify the spun yarn precursor α; and a spun yarn production step of producing the spun yarn by electrically heating the spun yarn precursor β while applying a tension to the spun yarn precursor β.
(2) In the spun yarn precursor β production step, the tension may be applied to the spun yarn precursor α while bringing the spun yarn precursor α into contact with a liquid selected from the group consisting of methanol, ethanol, acetone, water, paraffin and toluene, and mixtures of these substances.
(3) In the spun yarn precursor β production step, the tension may be applied stepwise to the spun yarn precursor α a plurality of times.
(4) In the spun yarn production step, the electrical heating may be performed at a temperature of 3200 K or less.
(5) In the spun yarn production step, the electrical heating may be performed while applying the tension of less than 480 MPa to the spun yarn precursor β.
(6) The method of the above aspect may further include a crosslinking step of impregnating the spun yarn obtained in the spun yarn production step with an aqueous solution containing a salt of sulfide.
(7) The salt of sulfide may be sodium tetrasulfide or sodium disulfide.
(8) In a spun yarn made of carbon nanotubes, a ratio (IG/ID) of intensity (IG) of G band peak to intensity (ID) of D band peak in a spectrum obtained by Raman spectroscopy is 5 or more, and graphene is present in at least a part of the carbon nanotubes.
(9) The carbon nanotubes may be crosslinked by a disulfide bond, a trisulfide bond or a tetrasulfide bond.

According to the present disclosure, means for producing a high strength CNT spun yarn can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the Young's moduli of CNT spun yarns obtained by performing a spun yarn precursor β production step while applying a tension with different loads and then performing a spun yarn production step without performing electrical heating in test I-4, where the abscissa represents the load (mN) in the spun yarn precursor β production step, and the ordinate represents the Young's modulus (GPa), and the values in the figure indicate the average values and standard deviations of three test results;

FIG. 2 shows the breaking stresses of the CNT spun yarns obtained by performing the spun yarn precursor β production step while applying a tension with different loads and then performing the spun yarn production step without performing electrical heating in test I-4, where the abscissa represents the load (mN) in the spun yarn precursor β production step, and the ordinate represents the breaking stress (GPa), and the values in the figure indicate the average values and standard deviations of three test results;

FIG. 3 shows the density of the CNT spun yarns obtained by performing the spun yarn precursor β production step while applying a tension with different loads and then performing the spun yarn production step without performing electrical heating in test I-4, where the abscissa represents the load (mN) in the spun yarn precursor β production step, and the ordinate represents the density (g/cm³), and the values in the figure indicate the average values and standard deviations of test results obtained from cross-sectional areas measured at six points;

FIG. 4 shows the density of CNT spun yarns obtained under various treatment conditions in test II-1, where the abscissa represents the treatment conditions (tension and electrical heating temperature) in the spun yarn production step, and the ordinate represents the density (g/cm³), the white bars indicate the results obtained when the spun yarn precursor β production step was performed under no load, and the black bars indicate the results obtained when the spun yarn precursor β production step was performed under load, and the values in the figure indicate the average values and standard deviations of test results obtained from cross-sectional areas measured at six points;

FIG. 5 shows Raman spectra in the range of 1000 cm⁻¹ to 2000 cm⁻¹ of CNT spun yarns obtained by performing the spun yarn precursor β production step under load in test II-2, where the abscissa represents Raman shift (cm⁻¹), and the ordinate represents the intensity of Raman scattered light (a.u.);

FIG. 6 shows Raman spectra in the range of 2200 cm⁻¹ to 3400 cm⁻¹ of CNT spun yarns obtained by performing the spun yarn precursor β production step under no load in test II-2, where the abscissa represents Raman shift (cm⁻¹), and the ordinate represents the intensity of Raman scattered light (a.u.);

FIG. 7A shows Raman spectra in the range of 2200 cm⁻¹ to 3400 cm⁻¹ of CNT spun yarns obtained by performing the spun yarn precursor β production step under load in test II-2, specifically Raman spectra of an untreated control CNT spun yarn and CNT spun yarns obtained by performing electrical heating at 2500 K, where the abscissa represents Raman shift (cm⁻¹), and the ordinate represents the intensity of Raman scattered light (a.u.);

FIG. 7B shows Raman spectra in the range of 2200 cm⁻¹ to 3400 cm⁻¹ of CNT spun yarns obtained by performing the spun yarn precursor β production step under load in test II-2, specifically Raman spectra of an untreated control CNT spun yarn and CNT spun yarns obtained by performing electrical heating at 3000 K, where the abscissa represents Raman shift (cm⁻¹), and the ordinate represents the intensity of Raman scattered light (a.u.);

FIG. 8 shows images of the CNT spun yarns obtained with a transmission electron microscope in test II-3, where image A is a transmission electron microscope image of an untreated control CNT spun yarn, image B is a transmission electron microscope image of a CNT spun yarn obtained by performing the spun yarn precursor β production step under no load and then performing electrical heating at 2500 K while applying a tension with a load of 100 mN (300 MPa to a spun yarn precursor β), image C is a transmission electron microscope image of a CNT spun yarn obtained by performing the spun yarn precursor β production step under load and then performing electrical heating at 2500 K while applying a tension with a load of 100 mN (300 MPa to the spun yarn precursor β), and image D is a transmission electron microscope image of the CNT spun yarn obtained by performing the spun yarn precursor β production step under load and then performing electrical heating at 3000 K while applying a tension with a load of 100 mN (300 MPa to the spun yarn precursor β), and the scale bar in the figure is 10 nm;

FIG. 9 shows the relationship between the electrical heating temperature in the spun yarn production step and the Young's modulus of the resultant CNT spun yarns in test II-4, where the abscissa represents the electrical heating temperature (K) in the spun yarn production step, and the ordinate represents the Young's modulus (GPa) of the CNT spun yarns, dashed lines in the figure show the Young's modulus of untreated control CNT spun yarns obtained by performing the spun yarn precursor β production step under load or no load, and the values in the figure indicate the average values and standard deviations of three test results; and

FIG. 10 shows the relationship between the temperature of the electrical heating temperature in the spun yarn production step and the breaking stress of the resultant CNT spun yarns in test II-4, where the abscissa represents the electrical heating temperature (K) in the spun yarn production step, and the ordinate represents the breaking stress (GPa) of the CNT spun yarns, dashed lines in the figure show the breaking stress of the untreated control CNT spun yarns obtained by performing the spun yarn precursor β production step under load or no load, and the values in the figure indicate the average values and standard deviations of three test results;

FIG. 11 shows scanning electron microscope images of the surfaces of the CNT spun yarns obtained by the method including the crosslinking step in test III-2, where image A is a scanning electron microscope image of the CNT spun yarn obtained by impregnation for two hours in the crosslinking step, image B is a scanning electron microscope image of the CNT spun yarn obtained by impregnation for 24 hours in the crosslinking step, image C is a scanning electron microscope image of the CNT spun yarn obtained by impregnation for 48 hours in the crosslinking step, and the scale bar in the figure is 10 μm;

FIG. 12A is a graph showing diameters of the CNT spun yarns obtained by the method including the crosslinking step in test III-2, where the abscissa represents the impregnation time in the crosslinking step and the ordinate represents the diameter (μm) of the CNT spun yarn;

FIG. 12B is a graph showing densities of the CNT spun yarns obtained by the method including the crosslinking step in test III-2, where the abscissa represents the impregnation time in the crosslinking step and the ordinate represents the density (g/cm³) of the CNT spun yarn;

FIG. 13 shows scanning electron microscope images of the cross sections of the CNT spun yarns obtained by the method including the crosslinking step in test III-3, where image A is a scanning electron microscope image of the CNT spun yarn obtained by impregnation for two hours in the crosslinking step, image B is a scanning electron microscope image of the CNT spun yarn obtained by impregnation for 24 hours in the crosslinking step, image C is a scanning electron microscope image of the CNT spun yarn obtained by impregnation for 48 hours in the crosslinking step, and dots in the images show sulfur atoms present in the cross sections of the CNT spun yarns and mapped using an energy dispersive X-ray spectrometry (EDS);

FIG. 14A shows results of quantification of the sulfur atoms present in the cross sections of the CNT spun yarns obtained by the method including the crosslinking step, the sulfur atoms being quantified using the EDS in test III-3, and is a graph showing percentages of the numbers of sulfur atoms relative to the total numbers of atoms present in the cross sections of the CNT spun yarns, where the abscissa represents the impregnation time in the crosslinking step and the ordinate represents the percentage (%) of the number of sulfur atoms;

FIG. 14B shows results of quantification of the sulfur atoms present in the cross sections of the CNT spun yarns obtained by the method including the crosslinking step, the sulfur atoms being quantified using the EDS in test III-3, and is a graph showing percentages of the sulfur atomic mass relative to the total atomic mass present in the cross sections of the CNT spun yarns, where the abscissa represents the impregnation time in the crosslinking step and the ordinate represents the percentage (%) of the sulfur atomic mass;

FIG. 15 is a graph showing stress-strain curves of the CNT spun yarns obtained by the method including the crosslinking step in test III-4, where the abscissa represents the strain rate (%), and the ordinate represents the breaking stress (GPa) of the CNT spun yarn;

FIG. 16 shows stress-strain curves of the CNT spun yarns obtained by the method including the crosslinking step in test III-5, where the abscissa represents the strain rate (%), and the ordinate represents the breaking stress (GPa) of the CNT spun yarn; and

FIG. 17 shows stress-strain curves of the CNT spun yarns obtained by the method including the crosslinking step in test III-5, where the abscissa represents the strain rate (%), and the ordinate represents the breaking stress (GPa) of the CNT spun yarn.

### DETAILED DESCRIPTION OF EMBODIMENTS

Hereinafter, an embodiment of the present disclosure will be described in detail.

### 1. Method for Manufacturing Spun Yarn Made of Carbon Nanotubes

The inventors found that the electrical heating temperature and the tension to be applied can be increased as compared to the methods of the related art by preliminarily applying, before electrically heating a spun yarn made of CNTs (CNT spun yarn), a high tension within such a range that the CNT spun yarn does not break to densify the CNT spun yarn. The inventors found that a CNT spun yarn produced by the above method has high crystallinity and high strength. Accordingly, one aspect of the present disclosure relates to a method for manufacturing a spun yarn made of CNTs.

In each aspect of the present disclosure, the CNT means a carbon material in which a single layer of graphite has a tubular structure. CNTs are usually classified into two types: single-walled CNTs having a single-layer tubular structure, and multi-walled CNTs having a multi-layer tubular structure. The CNTs applied to each aspect of the present disclosure may be either single-walled CNTs or multi-walled CNTs.

A method of the aspect includes at least a spun yarn precursor α production step, a spun yarn precursor β production step, and a spun yarn production step. Each step will be described below.

### 1-1. CNT Forest Preparation Step

The method of the aspect may include a CNT forest preparation step of preparing a CNT forest.

In each aspect of the present disclosure, the CNT forest means a collection of CNTs having a structure in which at least portions in the axial direction of a plurality of CNTs are aligned in a certain direction.

The shape and dimensions of the CNT forest prepared in this step is not particularly limited, and may be any shape and dimensions. The CNT forest has, for example, a quadrangular shape whose sides have a length in the range of 5 mm to 1000 mm, preferably 10 mm to 40 mm.

The CNT forest prepared in this step can be prepared by various methods known in the art. For example, the CNT forest can be formed by placing catalyst particles serving as growth nuclei on the surface of a metal substrate and bringing a carbon-containing raw material gas into contact with the surface of the substrate in a reactor. In this step, the CNT forest may be prepared by various methods known in the art, or may be prepared by purchasing etc.

### 1-2. Spun Yarn Precursor α Production Step

This step includes producing a spun yarn precursor α made of CNTs (hereinafter also referred to as “CNT spun yarn precursor α”) by pulling the plurality of CNTs from the CNT forest and spinning the CNTs while applying a tension to them.

In this step, various means that are usually used in the art can be used as means for pulling the CNTs from the CNT forest. For example, a combing blade with a plurality of blades may be placed on the upper surface of the CNT forest substrate, and a CNT web made of a plurality of CNTs is pulled from between the blades. In the present embodiment, the combing blade preferably has three or more blades.

In this step, the formed CNT spun yarn precursor α is collected by winding it around the peripheral surface of a rotating body. The rotating body is, for example, a bobbin or a roller. Since the CNT spun yarn precursor α is wound around the peripheral surface of the rotating body, the CNTs can be pulled from the CNT forest at a desired pulling speed and a desired tension can be applied to the CNTs.

In this step, the pulling speed at which the CNTs are pulled from the CNT forest is preferably in the range of 100 mm/min to 1000 mm/min, more preferably in the range of 200 mm/min to 500 mm/min.

In this step, the CNT forest may be rotated at a predetermined rotational speed to spin the CNTs. In the present embodiment, the rotational speed of the CNT forest is preferably less than 2000 rpm, more preferably 100 rpm to 1000 rpm, and even more preferably 200 rpm to 500 rpm. The ratio of the rotational speed of the CNT forest to the pulling speed of the CNTs is preferably in the range of more than 0.25 rev/mm and less than 25 rev/mm.

In this step, the tension that is applied to the CNTs is usually 6 mN or less per centimeter of the width of the CNT forest. The tension that is applied to the CNTs is preferably in the range of 0.1 mN to 6 mN per centimeter of the width of the CNT forest, more preferably in the range of 0.3 mN to 3 mN per centimeter of the width of the CNT forest, even more preferably in the range of 0.3 mN to 1 mN per centimeter of the width of the CNT forest. For example, when the CNT forest has the shape and dimensions mentioned above, the tension that is applied to the CNTs is usually 10 mN (30 MPa to the CNTs) or less, and is preferably in the range of 0.15 mN to 10 mN, more preferably in the range of 0.5 mN to 5 mN (1.6 MPa to 16 MPa to the CNTs), even more preferably in the range of 0.5 mN to 2 mN (1.6 MPa to 6.4 MPa to the CNTs). When the tension is lower than the above lower limit, the resultant CNT spun yarn precursor α may have a low density. When the tension is higher the above upper limit, the CNTs may break and a CNT spun yarn precursor α may not be able to be obtained. Accordingly, a high density CNT spun yarn precursor α can be obtained by performing this step while applying a tension in the above range to the CNTs.

In this step, a tension can usually be applied to the CNTs pulled from the CNT forest by applying a load to the CNTs using, for example, a tensioning rod, a slider system, or a motor.

In this step, a tension may be applied to the CNTs while bringing the CNTs pulled from the CNT forest into contact with a liquid. In the present embodiment, the liquid may be selected from the group consisting of methanol, ethanol, acetone, water, paraffin and toluene, and mixtures thereof, preferably selected from the group consisting of methanol, ethanol, acetone and water, and mixtures thereof. The liquid may contain one or more additional components such as metal salts (e.g., iron chloride or nickel chloride) or metal oxides (e.g., iron oxide). Particularly preferably, the liquid is methanol, ethanol, acetone, or water. In the present embodiment, examples of the means for bringing the CNTs into contact with a liquid include, but are not limited to, impregnating the CNTs with a liquid, spraying a liquid onto the CNTs, dropping a liquid onto the CNTs, and exposing the CNTs to a vapor of a liquid. It is preferable to bring the CNTs into contact with a liquid by impregnating the CNTs with the liquid. In the present embodiment, it is preferable to dry the CNTs brought into contact with a liquid at room temperature or higher. By bringing the CNTs into contact with a liquid by the above means, the CNTs can be agglomerated using the cohesive force due to vaporization of the liquid, and the density of the resultant CNT spun yarn precursor α can be increased.

The twist angle of the CNT spun yarn precursor α formed in this step is usually about 4°. The density of the CNT spun yarn precursor α is usually less than 0.7 g/cm³. The Young's modulus of the CNT spun yarn precursor α is usually less than 100 GPa. The breaking stress of the CNT spun yarn precursor α is usually less than 1.4 GPa. By using the CNT spun yarn precursor α having the above properties in the following step, a high strength CNT spun yarn can be obtained by the method of this aspect.

### 1-3. Spun Yarn Precursor β Production Step

This step includes producing a spun yarn precursor β by applying a higher tension than in the spun yarn precursor α production step to the spun yarn precursor α to densify the spun yarn precursor α. The purpose of this step is to densify the spun yarn precursor α by preliminarily applying, before electrically heating a spun yarn precursor β in the spun yarn production step, a high tension to the spun yarn precursor α within such a range that the spun yarn precursor α does not break.

For example, this step can be performed by pulling the spun yarn precursor α obtained in the spun yarn precursor α production step from the peripheral surface of the rotating body and applying a tension to the spun yarn precursor α. The spun yarn precursor β thus formed is collected by winding it around the peripheral surface of a rotating body. The rotating body is, for example, a bobbin or a roller. Since the spun yarn precursor β is wound around the peripheral surface of the rotating body, the spun yarn precursor α can be pulled out at a desired pulling speed, and a desired tension can be applied to the spun yarn precursor α.

In this step, the pulling speed at which the spun yarn precursor α is pulled is preferably less than 4000 mm/min, more preferably in the range of 1000 mm/min to 3000 mm/min.

In this step, the tension that is applied to the spun yarn precursor α is higher than that in the spun yarn precursor α production step. The tension that is applied to the spun yarn precursor α is, for example, less than 150 mN (480 MPa to the spun yarn precursor α), preferably in the range of 0.5 mN to 120 mN (1.6 MPa to 380 MPa to the spun yarn precursor α), more preferably in the range of 1 mN to 100 mN (3 MPa to 300 MPa to the spun yarn precursor α). When the tension is lower than the above lower limit, the resultant CNT spun yarn precursor β may have a low density. When the tension is higher the above upper limit, the spun yarn precursor α may break, and a CNT spun yarn precursor β may not be able to be obtained. Accordingly, a high density CNT spun yarn precursor β can be obtained by performing this step while applying a tension in the above range to the spun yarn precursor α and thus densifying the spun yarn precursor α. A high strength CNT spun yarn is thus obtained.

In this step, a tension may be applied stepwise to the spun yarn precursor α a plurality of times. In the present embodiment, the tension is increased stepwise from substantially the same tension as in the spun yarn precursor α production step and is repeatedly applied stepwise to the spun yarn precursor α a plurality of times. In this case, the number of times the tension is applied to the spun yarn precursor α is preferably two or more times, more preferably two times to five times, even more preferably three times. The tension applied to the spun yarn precursor α the first time is preferably in the range of 0.5 mN to 10 mN (1.6 MPa to 30 MPa to the spun yarn precursor α), more preferably in the range of 1 mN to 10 mN (3 MPa to 30 MPa to the spun yarn precursor α). The tension that is applied to the spun yarn precursor α in the final stage is preferably in the range of 10 mN to 120 mN (30 MPa to 380 MPa to the spun yarn precursor α), more preferably in the range of 20 mN to 100 mN (64 MPa to 300 MPa to the spun yarn precursor α), and even more preferably in the range of 50 mN to 100 mN (160 MPa to 300 MPa to the spun yarn precursor α). In a particular embodiment, it is preferable to apply a tension to the spun yarn precursor α stepwise three times by sequentially increasing the tension to 1 mN, 50 mN, and 100 mN (3 MPa, 160 MPa, and 300 MPa to the spun yarn precursor α) in this order. When the number of times the tension is applied to the spun yarn precursor α is less than the above lower limit and when the tension that is applied the first time is higher than the above upper limit, the spun yarn precursor α may break due to a sharp increase in tension, and a CNT spun yarn precursor β may not be able to be obtained. When the number of times the tension is applied to the spun yarn precursor α is more than the above upper limit, the cost of the method of this aspect may increase due to long treatment time. Accordingly, a high density CNT spun yarn precursor β can be stably obtained by performing this step under the above conditions and thus densifying the spun yarn precursor α. A high strength CNT spun yarn is thus obtained.

In this step, a tension can usually be applied to the spun yarn precursor α pulled from the peripheral surface of the rotating body by applying a load to the spun yarn precursor α using, for example, a tensioning rod, a slider system, or a motor.

In this step, a tension may be applied to the spun yarn precursor α while bringing the spun yarn precursor α into contact with a liquid. In the present embodiment, the liquid may be selected from the group consisting of methanol, ethanol, acetone, water, paraffin and toluene, and mixtures thereof, preferably selected from the group consisting of methanol, ethanol, acetone and water, and mixtures thereof. The liquid may contain one or more additional components such as metal salts (e.g., iron chloride or nickel chloride) or metal oxides (e.g., iron oxide). Particularly preferably, the liquid is methanol, ethanol, acetone, or water. In the present embodiment, examples of the means for bringing the spun yarn precursor α into contact with a liquid include, but are not limited to, impregnating the spun yarn precursor α with a liquid, spraying a liquid onto the spun yarn precursor α, dropping a liquid onto the spun yarn precursor α, and exposing the spun yarn precursor α to a vapor of a liquid. It is preferable to bring the spun yarn precursor α into contact with a liquid by impregnating the spun yarn precursor α with the liquid. In the present embodiment, it is preferable to dry the spun yarn precursor α brought into contact with a liquid at room temperature or higher. By bringing the spun yarn precursor α into contact with a liquid by the above means, the CNTs can be agglomerated using the cohesive force due to vaporization of the liquid, and the density of the resultant CNT spun yarn precursor β can be increased.

A high density CNT spun yarn precursor β can be stably obtained by performing this step under the above conditions and thus densifying the spun yarn precursor α. The density of the spun yarn precursor β formed in this step is usually 1.0 g/cm³ or higher, for example, in the range of 1.0 g/cm³ to 1.2 g/cm³. The Young's modulus of the CNT spun yarn precursor β is usually 100 GPa or more, for example, in the range of 100 GPa to 150 GPa. The breaking stress of the CNT spun yarn precursor β is usually 1.4 GPa or more, for example, in the range of 1.4 GPa to 2 GPa. By using the CNT spun yarn precursor β having the above properties in the following step, a high strength CNT spun yarn can be obtained by the method of this aspect.

### 1-4. Spun Yarn Production Step

This step includes producing a spun yarn made of carbon nanotubes by electrically heating the spun yarn precursor β while applying a tension thereto.

For example, this step can be performed by pulling the spun yarn precursor βobtained in the spun yarn precursor β production step from the peripheral surface of the rotating body and electrically heating the spun yarn precursor β while applying a tension thereto. The CNT spun yarn thus formed is collected by winding it around the peripheral surface of a rotating body. The rotating body is, for example, a bobbin or a roller. Since the CNT spun yarn is wound around the peripheral surface of the rotating body, the spun yarn precursor β can be pulled out at a desired pulling speed, and a desired tension can be applied to the spun yarn precursor β.

In this step, the pulling speed at which the spun yarn precursor β is pulled is preferably in the range of more than 60 mm/min to 6000 mm/min, more preferably in the range of 100 mm/min to 1000 mm/min, even more preferably in the range of 100 mm/min to 600 mm/min.

In this step, the tension that is applied to the spun yarn precursor β need only be the same as or higher than that in the spun yarn precursor β producing step. The tension that is applied to the spun yarn precursor β is, for example, less than 150 mN (480 MPa to the spun yarn precursor β), preferably in the range of 0.5 mN to 120 mN (1.6 MPa to 380 MPa to the spun yarn precursor β), more preferably in the range of 1 mN to 100 mN (3 MPa to 300 MPa to the spun yarn precursor β). When the tension is lower than the above lower limit, the resultant CNT spun yarn may have a low density. When the tension is higher the above upper limit, the spun yarn precursor β may break, and a CNT spun yarn may not be able to be obtained. Accordingly, a high density CNT spun yarn can be obtained by performing this step while applying a tension in the above range to the spun yarn precursor β and thus densifying the spun yarn precursor β. A high strength CNT spun yarn is thus obtained.

In this step, a tension can usually be applied to the spun yarn precursor β pulled from the peripheral surface of the rotating body by applying a load to the spun yarn precursor β using, for example, a tensioning rod, a slider system, or a motor.

In this step, the means for electrically heating the spun yarn precursor β is not particularly limited, and various means usually used in the art can be used. This step may be performed using a heater (e.g., a quartz heater) in an inert gas (e.g., gas such as argon) atmosphere, or may be performed using an atmosphere furnace equipped with a tension application mechanism and capable of heating at ultrahigh temperatures. In the present embodiment, the distance between electrodes of the heater is preferably in the range of 1 mm to 50 mm, more preferably in the range of 1 mm to 10 mm.

In this step, the electrical heating temperature may be 3200 K or less, preferably in the range of above room temperature to 3200 K or less, more preferably in the range of 1000 K to 3200 K, and particularly preferably in the range of 2000 K to 3000 K. When the electrical heating temperature is lower than the above lower limit, amorphous carbon in the CNTs contained in the spun yarn precursor β may not be sufficiently transformed into graphene. When the electrical heating temperature is higher the above upper limit, the spun yarn precursor β may break, and a CNT spun yarn may not be able to be obtained. Accordingly, a high strength CNT spun yarn can be obtained by performing this step under the above conditions to transform at least a part of amorphous carbon in the CNTs contained in the spun yarn precursor β into graphene.

In this step, the electrical heating time is preferably in the range of more than 0.1 seconds and less than 10 seconds, more preferably in the range of 0.5 seconds to 10 seconds, and even more preferably in the range of 0.5 seconds to 1 second. When the electrical heating time is less than the above lower limit, amorphous carbon in the CNTs contained in the spun yarn precursor β may not be sufficiently transformed into graphene. When the electrical heating time is more than the above upper limit, the spun yarn precursor β may break, and a CNT spun yarn may not be able to be obtained. Accordingly, a high strength CNT spun yarn can be obtained by performing this step under the above conditions to transform at least a part of amorphous carbon in the CNTs contained in the spun yarn precursor β into graphene.

In this step, it is preferable to apply a tension to the spun yarn precursor β while bringing the spun yarn precursor β into contact with a liquid. In the present embodiment, the liquid is preferably selected from the group consisting of methanol, ethanol, acetone, water, paraffin and toluene, and mixtures thereof, more preferably selected from the group consisting of methanol, ethanol, acetone, water and paraffin, and mixtures thereof. The liquid may contain one or more additional components such as metal salts (e.g., iron chloride or nickel chloride) or metal oxides (e.g., iron oxide). Particularly preferably, the liquid is methanol, ethanol, acetone, water, paraffin or an iron chloride ethanol solution. In the present embodiment, examples of the means for bringing the spun yarn precursor β into contact with a liquid include, but are not limited to, impregnating the spun yarn precursor β with a liquid, spraying a liquid onto the spun yarn precursor β, dropping a liquid onto the spun yarn precursor β, and exposing the spun yarn precursor β to a vapor of a liquid. It is preferable to bring the spun yarn precursor β into contact with a liquid by impregnating the spun yarn precursor β with the liquid. In the present embodiment, it is preferable to dry the spun yarn precursor β brought into contact with a liquid at room temperature or higher. By bringing the spun yarn precursor β into contact with a liquid by the above means, the CNTs can be agglomerated using the cohesive force due to vaporization of the liquid, and the density of the resultant CNT spun yarn can be increased.

Accordingly, a high density, high strength CNT spun yarn can be obtained by performing this step under the above conditions to densify the spun yarn precursor β and/or to transform at least a part of amorphous carbon in the spun yarn precursor β into graphene.

### 1-5. Crosslinking Step

The method of the aspect may further include a crosslinking step of impregnating a spun yarn made of carbon nanotubes obtained in the spun yarn production step with an aqueous solution containing a salt of sulfide.

In each aspect of the present disclosure, the salt of sulfide used in the crosslinking step may be referred to as “sulfurizing agent”. It is predicted by simulation that when the CNT spun yarn is treated with a sulfurizing agent, the CNTs are crosslinked by disulfide bonds, and when a tensile force is applied to the crosslinked CNT spun yarn, the disulfide bonds recombine a number of times to improve the tensile strength (Composite Science and Technology, 2018, Vol. 166, pages 3 to 9). It was found that in the method of the aspect, by treating the CNT spun yarn obtained in the spun yarn production step with an aqueous solution containing a sulfurizing agent, the CNTs constituting the CNT spun yarn are crosslinked by disulfide bonds, trisulfide bonds, or tetrasulfide bonds so that voids decrease and the density of the CNT spun yarn increases. Therefore, by performing the crosslinking step, it is possible to further improve the density and the strength of the resulting CNT spun yarn.

In this step, the salt of sulfide used as the sulfurizing agent is preferably a salt of tetrasulfide, trifluide or disulfide, more preferably, a salt of tetrasulfide or disulfide, even more preferably, a salt of tetrasulfide or disulfide with sodium ion, potassium ion, calcium ion, or magnesium ion, and particularly preferably sodium tetrasulfide or sodium disulfide. When the salt of sulfide is a salt of tetrasulfide and the counterion mentioned above, particularly sodium tetrasulfide, the strain resistance of the CNT spun yarn can be further improved by performing this step. When the salt of sulfide is a salt of disulfide and the counterion mentioned above, particularly sodium disulfide, the breaking stress of the CNT spun yarn can be further improved by performing this step. Therefore, by performing this step using the salt of sulfide mentioned above, it is possible to further improve the strength of the resulting CNT spun yarn.

In this step, the concentration of the salt of sulfide in the aqueous solution of the salt of sulfide is preferably 1 mmol/L or more, more preferably in a range of 1 mmol/L to 500 mmol/L, even more preferably in a range of 1 mmol/L to 200 mmol/L, and particularly preferably in a range of 1 mmol/L to 100 mmol/L. When the concentration of the salt of sulfide is less than the above lower limit, introduction of disulfide bonds and the like between the CNTs constituting the CNT spun yarn becomes insufficient, so that improvement of the density and/or the strength of the resulting CNT spun yarn may be insufficient. Therefore, by performing this step under the above conditions, it is possible to further improve the density and the strength of the resulting CNT spun yarn.

The aqueous solution of the salt of sulfide used in this step may contain one or more further components such as water-miscible organic solvent, if desired. Examples of the water-miscible organic solvent include methanol, ethanol, and acetone.

In this step, the impregnation time for impregnating the CNT spun yarn with the aqueous solution containing the salt of sulfide is usually one hour or more, preferably two hours or more, more preferably 24 hours or more, and even more preferably 48 hours or more. The maximum impregnation time is not particularly limited, but is usually 72 hours or less, for example 60 hours or less, and especially 48 hours or less. When the impregnation time is less than the above lower limit, introduction of disulfide bonds and the like between the CNTs constituting the CNT spun yarn becomes insufficient, so that improvement of the density and/or the strength of the resulting CNT spun yarn may be insufficient. Therefore, by performing this step under the above conditions, it is possible to further improve the density and the strength of the resulting CNT spun yarn.

In this step, the impregnation temperature for impregnating the CNT spun yarn with the aqueous solution containing the salt of sulfide is usually room temperature or higher, preferably 10° C. or higher, and more preferably in a range of 10° C. to 60° C. When the impregnation temperature is lower than the above lower limit, introduction of disulfide bonds and the like between the CNTs constituting the CNT spun yarn becomes insufficient, so that improvement of the density and/or the strength of the resulting CNT spun yarn may be insufficient. Therefore, by performing this step under the above conditions, it is possible to further improve the density and the strength of the resulting CNT spun yarn.

In this step, the CNT spun yarn impregnated with the aqueous solution containing the salt of sulfide is preferably dried. In the present embodiment, the drying temperature is usually room temperature or higher, preferably 20° C. or higher, and more preferably in the range of 20° C. to 100° C. The drying time is usually several minutes or more, preferably five minutes or more and several days or less, more preferably in the range of five minutes to one day, and even more preferably in the range of five minutes to one hour. In a specific embodiment, the CNT spun yarn impregnated with the aqueous solution containing the salt of sulfide is preferably dried naturally at room temperature for one day or vacuum dried at 80° C. for one hour. If the impregnation temperature and/or the impregnation time is less than the lower limit mentioned above, drying of the CNT spun yarn may be insufficient. Therefore, by performing this step under the above conditions, it is possible to obtain the CNT spun yarn with desired properties.

In the method of this aspect, the steps described above may be carried out sequentially or continuously. In the method of this aspect, it is preferable to continuously perform the steps described above. By continuously performing the steps of the method of this aspect, a high density, high strength CNT spun yarn can be manufactured efficiently at low cost.

### 2. Spun Yarn Made of Carbon Nanotubes

As described above, a high density, high strength CNT spun yarn can be obtained by the manufacturing method of the aspect of the present disclosure. Another aspect of the present disclosure relates to a spun yarn (CNT spun yarn) made of carbon nanotubes that can be obtained by the manufacturing method of the aspect of the present disclosure, preferably carbon nanotubes obtained by the manufacturing method of the aspect of the present disclosure.

In each aspect of the present disclosure, the densities of the CNT spun yarn precursor α, the CNT spun yarn precursor β, and the CNT spun yarn can be measured as, for example, bulk densities by the following method, although the present disclosure is not limited to this The weight per unit length of the CNT spun yarn precursor α, the CNT spun yarn precursor β, or the CNT spun yarn is measured using a microbalance. The cross-sectional area of the CNT spun yarn precursor α, the CNT spun yarn precursor β, or the CNT spun yarn is measured using a scanning electron microscope. The bulk density is then calculated from the weight per unit length and the cross-sectional area.

In each aspect of the present disclosure, the strengths of the CNT spun yarn precursor α, the CNT spun yarn precursor β, and the CNT spun yarn can be evaluated using, for example, Young's modulus and breaking stress as indexes. The Young's moduli and breaking stresses of the CNT spun yarn precursor α, the CNT spun yarn precursor β, and the CNT spun yarn can be measured at a test speed of 1 mm/min and a distance between grips of 25 mm based on ISO 11566:1996 (JIS R7606:2000).

The CNT spun yarn of this aspect usually has a density of less than 1.6 g/cm³, for example, in the range of more than 1.0 g/cm³ and less than 1.6 g/cm³, particularly in the range of 1.2 g/cm³ to 1.5 g/cm³. On the other hand, CNT spun yarns obtained by the methods of the related art in which no tension is preliminarily applied in the spun yarn precursor β production step usually have a density of 1.0 g/cm³ or less. Therefore, the CNT spun yarn of this aspect has a denser structure than the CNT spun yarns obtained by the methods of the related art.

In the CNT spun yarn of this aspect, the ratio (IG/ID) of the intensity (IG) of G band peak to the intensity (ID) of D band peak in the spectrum obtained by Raman spectroscopy is usually 5 or more, for example in the range of 5 to 35, particularly in the range of 5 to 25. On the other hand, the CNT spun yarns obtained by the methods of the related art in which no tension is preliminarily applied in the spun yarn precursor β production step, the IG/ID is usually less than 2, for example, less than 1.2. In this technical field, in the spectra obtained by Raman spectroscopy of CNTs and spun yarns made of CNTs (hereinafter also referred to as “Raman spectra”), the G band peak is known to be derived from the crystalline sp² structure, and the D band peak is known to be derived from a defect or amorphous sp³ structure. Therefore, in the Raman spectra of CNTs and a spun yarn made of CNTs, IG/ID is an index indicating CNT crystallinity. A presumed structural change of amorphous carbon in the CNTs to graphene can be confirmed by, for example, the presence of flake-like crystal structures, namely crystal structures indicating the presence of graphene, in an image obtained by observing the CNTs with a transmission electron microscope. Since the CNT spun yarn of this aspect has a higher IG/ID than the CNT spun yarns obtained by the methods of the related art, the CNT spun yarn of this aspect has higher CNT crystallinity than the CNT spun yarns obtained by the methods of the related art. Since the flake-shaped crystal structures are observed in a transmission electron microscope image of the CNT spun yarn of this aspect, graphene may be present in at least a part of the CNTs in the CNT spun yarn of this aspect. Therefore, the CNT spun yarn of this aspect has high crystallinity and a graphene structure that are not observed in the CNT spun yarns obtained by the methods of the related art.

The CNT spun yarn of this aspect has high strength due to its high crystallinity and graphene structure. The CNT spun yarn of this aspect usually has a Young's modulus of 100 GPa or more, for example, in the range of 100 GPa to 300 GPa, preferably in the range of 120 GPa to 260 GPa, particularly in the range of 190 GPa to 260 GPa. The CNT spun yarn of this aspect usually has a breaking stress of 1.4 GPa or more, for example, in the range of 1.4 GPa to 3.6 GPa, preferably in the range of 1.6 GPa to 3.4 GPa, particularly in the range of 2.2 GPa to 3.2 GPa. On the other hand, the CNT spun yarns obtained by the methods of the related art in which no tension is preliminarily applied in the spun yarn precursor β production step typically have a Young's modulus of less than 100 GPa and a breaking stress of less than 1.4 GPa. Therefore, the CNT spun yarn of this aspect has higher strength than the CNT spun yarns obtained by the methods of the related art.

In a specific embodiment, the CNTs in the CNT spun yarn of this aspect may be crosslinked by disulfide bonds, trisulfide bonds, or tetrasulfide bonds. The CNT spun yarn of this embodiment has one or more types of bond selected from the group consisting of a disulfide bond, a trisulfide bond, and a tetrasulfide bond, between the CNTs. The CNT spun yarn of this embodiment can be obtained by the manufacturing method according to an aspect of the present disclosure that includes the crosslinking step described above. The CNT spun yarn of this embodiment has higher density and higher strength.

Since the CNT spun yarn of this aspect has high strength in addition to thermal conductivity and electrical conductivity, it can be used as a high strength carbon material that replaces carbon fiber reinforced plastics (CFRPs). The CNT spun yarn of this aspect can be used as a material for parts such as parts for automobiles (e.g., high pressure tanks or bodies), parts for wind power generators (e.g., blades), or parts for aircrafts (e.g., bodies).

Hereinafter, the present disclosure will be described in more detail using examples. However, the technical scope of the present disclosure is not limited to these examples.

I. Manufacturing of Spun Yarn made of CNTs

### I-1. Spun Yarn Precursor α Production Step (1)

A combing blade with three blades was placed on the upper surface of an 18×18 mm CNT forest grown on the surface of a metal substrate. A CNT web made of a plurality of CNTs was pulled from between the blades at a substrate rotational speed of 500 rpm and a pulling speed of 500 mm/min. The CNT web was spun while applying a tension thereto with a load of less than 1 mN (3 MPa to the CNT web made of the CNTs), and a spun yarn precursor α made of the CNTs with a twist angle of about 4° was wound around the peripheral surface of a rotating body. In the above procedure, the load of less than 1 mN (3 MPa to the CNT web made of the CNTs) is equivalent to a tension of 0.55 mN per centimeter of the width of the CNT forest. The spun yarn precursor α was produced by the above procedure. The substrate rotational speed was varied within the range of less than 200 rpm, the ratio of the substrate rotational speed to the pulling speed was varied within the range of more than 0.25 rev/mm and less than 25 rev/mm, and the load was varied within the range of less than 10 mN (5.5 mN per centimeter of the width of the CNT forest, 30 MPa to the CNT web made of the CNTs). This step was also performed in a procedure of impregnating the CNT web with methanol, ethanol, acetone, or water while applying a load to the CNT web pulled from the CNT forest, and then winding the CNT web around the peripheral surface of the rotating body.

### I-2. Spun Yarn Precursor β Production Step

The spun yarn precursor α was pulled from the peripheral surface of the rotating body at a pulling speed of 2000 mm/min. The spun yarn precursor α was impregnated with ethanol while applying a higher tension than in the spun yarn precursor α production step to the spun yarn precursor α, and was then wound around the peripheral surface of a rotating body. In the above procedure, the load was sequentially increased to 1 mN, 50 mN, and 100 mN (3 MPa, 160 MPa, and 300 MPa to the spun yarn precursor α) in this order to repeatedly apply a tension to the spun yarn precursor α stepwise three times. By the above procedure, the spun yarn precursor α was densified to produce a spun yarn precursor β. The pulling speed was varied within the range of less than 4000 mm/min and the load was varied within the range of less than 150 mN (480 MPa to the spun yarn precursor α). This step was also performed in a procedure of impregnating the spun yarn precursor α with methanol, acetone, or water instead of ethanol.

### I-3. Spun Yarn Production Step

The spun yarn precursor β was pulled from the peripheral surface of the rotating body at a pulling speed of 600 mm/min. The spun yarn precursor β was electrically heated at a temperature of 1500 K to 3000 K for one second with a distance between electrodes of 10 mm while applying a tension to the spun yarn precursor β with a load of 1 mN, 10 mN, or 100 mN (3 MPa, 30 MPa, or 300 MPa to the spun yarn precursor β). Thereafter, the spun yarn precursor β was wound around the peripheral surface of a rotating body. A CNT spun yarn was produced by the above procedure. The pulling speed was varied within the range of more than 60 mm/min to 6000 mm/min, the load was varied within the range of less than 150 mN (480 MPa to the spun yarn precursor β), the electrical heating temperature was varied within the range of above room temperature to 3200 K or less, and the electrical heating time was varied within the range of more than 0.1 seconds and less than 10 seconds. This step was also performed in a procedure of impregnating the spun yarn precursor β with methanol, ethanol, acetone, water, paraffin, or an iron chloride ethanol solution and then electrically heating the spun yarn precursor β and winding the spun yarn precursor β around the peripheral surface of the rotating body.

### I-4. Effects of Load in Spun Yarn Precursor β Production Step

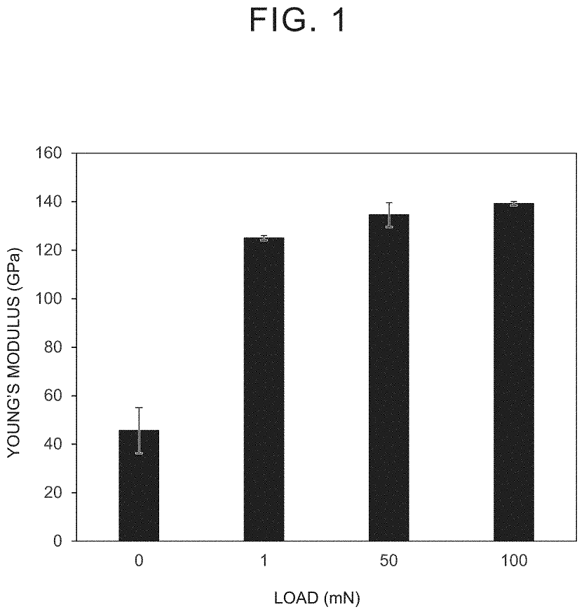

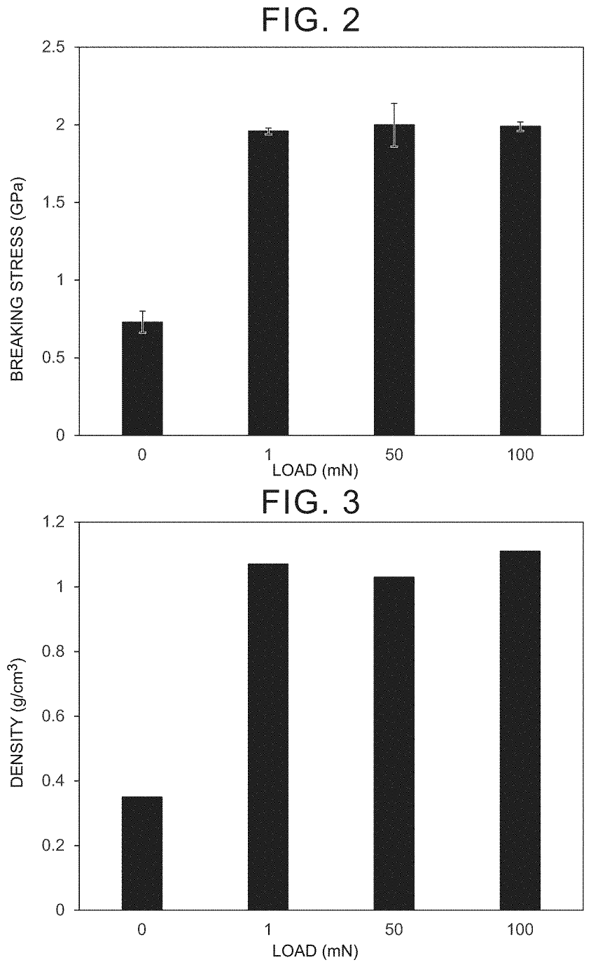

In the spun yarn precursor β production step, the spun yarn precursor β was produced by spinning the spun yarn precursor α while applying a tension thereto with a load of 1 mN, 50 mN, or 100 mN (3 MPa, 160 MPa, or 300 MPa to the spun yarn precursor α). Thereafter, in the spun yarn production step, the CNT spun yarn was produced without electrical heating. As a control, a CNT spun yarn was produced by a procedure similar to that described above except that the spun yarn precursor β was produced by spinning the spun yarn precursor α without applying a load in the spun yarn precursor β production step. The Young's moduli and breaking stresses of the obtained spun yarns were measured based on ISO 11566:1996 (JIS R7606:2000) at a test speed of 1 mm/min and a distance between grips of 25 mm. The densities of the obtained spun yarns were measured by the following procedure. The weight per unit length of the spun yarn was measured using a microbalance. The cross-sectional areas (six points) of the spun yarn were measured using a scanning electron microscope. The bulk density was then calculated from the weight per unit length and the cross-sectional area. The Young's moduli, breaking stresses, and densities of the obtained spun yarns are shown in FIGS. 1, 2, and 3, respectively. In the figures, the abscissa represents the load (mN) in the spun yarn precursor β production step. The values in FIGS. 1 and 2 indicate the average values and standard deviations of three test results. The values in FIG. 3 indicate the average values and standard deviations of test results obtained from the cross-sectional areas measured at six points.

As shown in FIGS. 1 to 3, when the spun yarn precursor α was spun while applying a load of 1 mN, 50 mN, and 100 mN (3 MPa, 160 MPa, and 300 MPa to the spun yarn precursor α) in the spun yarn precursor β production step, the Young's moduli, breaking stresses, and densities of the obtained CNT spun yarns were significantly higher than those of the control spun yarn.

### I-5. Effects of Electrical Heating in Spun Yarn Production Step

In the spun yarn precursor β production step, the spun yarn precursor β was produced by spinning the spun yarn precursor α under no load or while applying a tension thereto with a load of 100 mN (300 MPa to the spun yarn precursor α). Thereafter, in the spun yarn production step, the CNT spun yarn was produced by electrically heating the spun yarn precursor β at 1500, 2000, 2500, 3000, or 3500 K for one second with a distance between electrodes of 10 mm while applying a tension thereto with a load of 1 mN, 10 mN, or 100 mN (3 MPa, 30 MPa, or 300 MPa to the spun yarn precursor β). Table 1 shows the relationship between the electrical heating temperature in the spun yarn production step and the CNT spun yarn when the spun yarn precursor β production step was performed under no load. Table 2 shows the relationship between the electrical heating temperature in the spun yarn production step and the CNT spun yarn when the spun yarn precursor β production step was performed under load. In the table, × indicates that the spun yarn precursor β broke during electrical heating, and ∘ indicates that the CNT spun yarn was able to be produced satisfactorily.

TABLE 1

| Spun Yarn Precursor β | | | | | | |
|---|---|---|---|---|---|---|
| Production Step | | Electrical Heating Temperature (K.) | | | | |
| Under No Load | | 1500 | 2000 | 2500 | 3000 | 3500 |
| Load | 1 | ○ | ○ | ○ | x | x |
| (mN) | 10 | ○ | ○ | ○ | x | x |
| | 100 | ○ | ○ | ○ | x | x |

TABLE 2

| Spun Yarn Precursor β | | | | | | |
|---|---|---|---|---|---|---|
| Production Step | | Electrical Heating Temperature (K.) | | | | |
| Under Load | | 1500 | 2000 | 2500 | 3000 | 3500 |
| Load | 1 | ○ | ○ | ○ | ○ | x |
| (mN) | 10 | ○ | ○ | ○ | ○ | x |
| | 100 | ○ | ○ | ○ | ○ | x |

As shown in Table 1, in the case where the spun yarn precursor β production step was performed under no load, the spun yarn precursor β broke during electrical heating and a CNT spun yarn was not able to be obtained when the electrical heating was performed at 3000 K or higher. On the other hand, in the case where the spun yarn precursor β production step was performed while applying a load to the spun yarn precursor α, the spun yarn precursor β did not break during electrical heating and a CNT spun yarn was able to be obtained even when the electrical heating was performed at 3000 K or higher. As will be described below, the higher the electrical heating temperature in the spun yarn production step, the higher the strength of the resultant spun yarn. Therefore, the strength of the resultant spun yarn can be improved by performing the spun yarn precursor β production step while applying a tension to the spun yarn precursor α.

### II. Property Analysis of Spun Yarns Made of CNTs

### II-1. Densities of CNT Spun Yarns

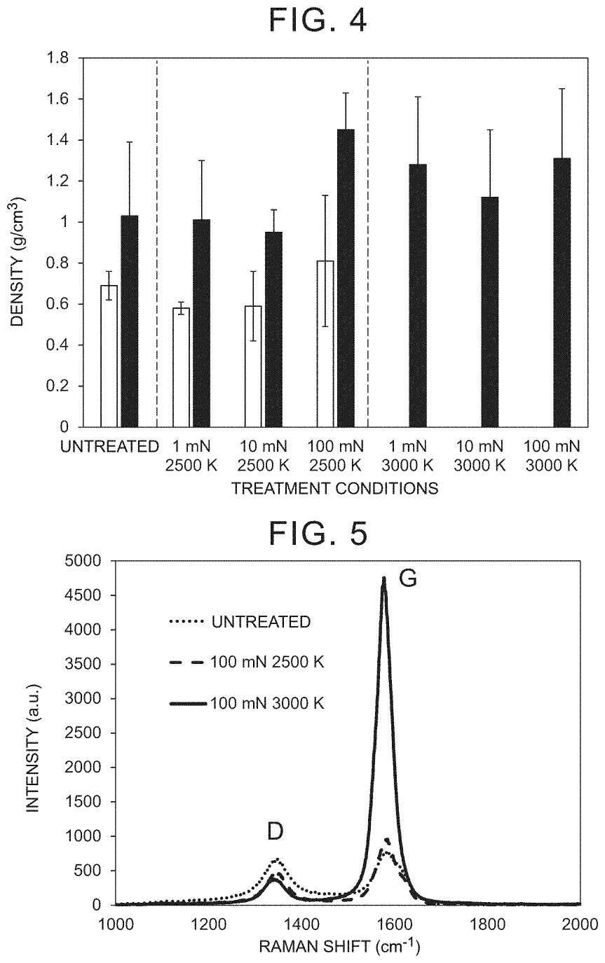

In the spun yarn precursor β production step, the spun yarn precursor β was produced by spinning the spun yarn precursor α under no load or while applying a tension thereto with a load of 100 mN (300 MPa to the spun yarn precursor α). Thereafter, in the spun yarn production step, the CNT spun yarn was produced by electrically heating the spun yarn precursor β at 2500 or 3000 K for one second with a distance between electrodes of 10 mm while applying a tension thereto with a load of 1 mN, 10 mN, or 100 mN (3 MPa, 30 MPa, or 300 MPa to the spun yarn precursor β). As a control, a CNT spun yarn was produced without electrical heating. FIG. 4 shows the densities of CNT spun yarns obtained under various treatment conditions. In the figure, the abscissa represents the treatment conditions (tension and electrical heating temperature) in the spun yarn production step, and the ordinate represents the density (g/cm³). The white bars indicate the results obtained when the spun yarn precursor β production step was performed under no load, and the black bars indicate the results obtained when the spun yarn precursor β production step was performed under load. The values in the figure indicate the average values and standard deviations of test results obtained from the cross-sectional areas measured at six points.

As shown in FIG. 4, when the spun yarn precursor β production step was performed under no load, the densities of the CNT spun yarns obtained by performing electrical heating at 2500 K were substantially about the same as the density of the untreated control CNT spun yarn. When performing electrical heating at 3000 K or higher, the spun yarn precursor β broke and during the electrical heating, and a CNT spun yarn was not able to be obtained. On the other hand, when the spun yarn precursor β production step was performed under load while applying a tension to the spun yarn precursor α, the densities of the CNT spun yarns obtained by performing electrical heating at 2500 K while applying a tension with a load of 100 mN (300 MPa to the spun yarn precursor β) were significantly higher than the density of the untreated control CNT spun yarn. The densities of the CNT spun yarns obtained by performing electrical heating at 3000 K while applying a tension with a load of any of 1 mN, 10 mN, and 100 mN (3 MPa, 30 MPa, and 300 MPa to the spun yarn precursor β) were significantly higher than the density of the untreated control CNT spun yarn.

### II-2. Analysis of Peaks Observed in Raman Spectra of CNT Spun Yarns

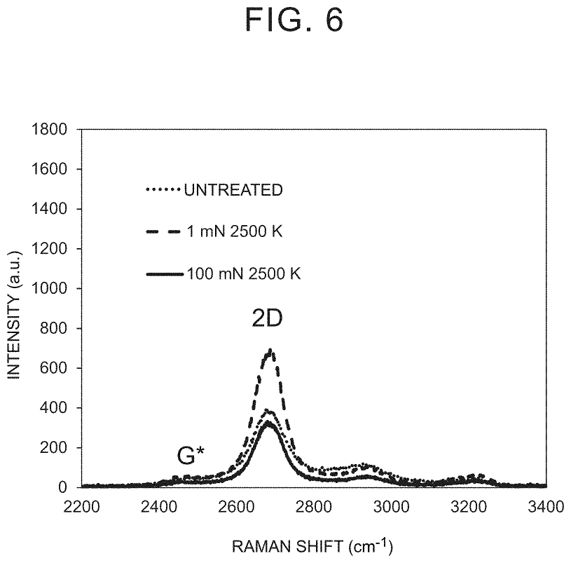

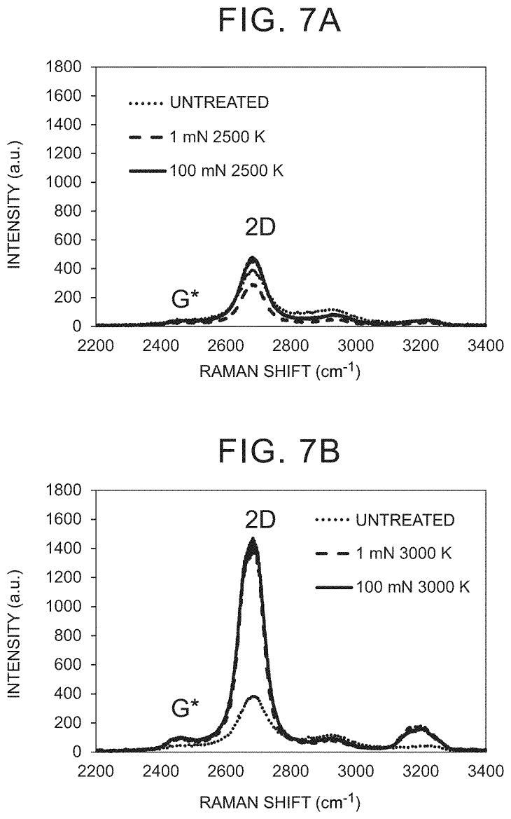

The spun yarns made of CNTs obtained in II-1 were subjected to Raman spectroscopy. FIG. 5 shows Raman spectra in the range of 1000 cm⁻¹ to 2000 cm⁻¹ of the CNT spun yarns obtained by performing the spun yarn precursor β production step under load. FIG. 6 shows Raman spectra in the range of 2200 cm⁻¹ to 3400 cm⁻¹ of the CNT spun yarns obtained by performing the spun yarn precursor β production step under no load. FIGS. 7A and 7B show Raman spectra in the range of 2200 cm⁻¹ to 3400 cm⁻¹ of the CNT spun yarns obtained by performing the spun yarn precursor β production step under load. In the figures, the abscissa represents Raman shift (cm⁻¹), and the ordinate represents the intensity of Raman scattered light (a.u.). FIG. 7A shows the Raman spectra of the untreated control CNT spun yarn and the CNT spun yarns obtained by performing electrical heating at 2500 K, and FIG. 7B shows the Raman spectra of the untreated control CNT spun yarn and the CNT spun yarns obtained by performing electrical heating at 3000 K.

As shown in FIG. 5, in the Raman spectra of the CNT spun yarns obtained by performing the spun yarn precursor β production step under load, the G band peak derived from a crystalline sp² structure and the D-band peak derived from a defect or amorphous sp³ structure were observed. The ratio (IG/ID) of the intensity (IG) of the G band peak and the intensity (ID) of the D band peak, namely the ratio that is an index indicating CNT crystallinity, is 1.2 for the untreated control CNT spun yarn, and 2.0 for the CNT spun yarns obtained by performing electrical heating at 2500 K while applying a tension with a load of 100 mN (300 MPa to the spun yarn precursor β), but 13 for the CNT spun yarns obtained by performing electrical heating at 3000 K while applying a tension with a load of 100 mN (300 MPa to the spun yarn precursor β). When the experiment was conducted a plurality of times under similar conditions, IG/ID was in the range of more than 0.8 and less than 1.2 for the untreated control CNT spun yarn, but in the range of more than 1.2 and less than 35, particularly less than 25 for the CNT spun yarns obtained by performing electrical heating while applying a tension.

In the Raman spectra, G* band peak is known to be derived from graphene (N. Ferralis, J. Mater. Sci. 45, 5135-5149 (2010), and M. S. Dresselhaus, et al., Nano Lett. 10 (3), 751-758 (2010)). As shown in FIGS. 6 to 7B, 2D band peak that is a secondary D band peak and G* band peak derived from graphene were observed in the Raman spectra of the CNT spun yarns obtained under each condition. In particular, the intensities of the G* band peaks of the CNT spun yarns obtained by performing electrical heating at 3000 K were twice or more the intensity of the G* band peak of the untreated control CNT spun yarn.

### II-3. Crystal Structure Analysis of CNT Spun Yarns

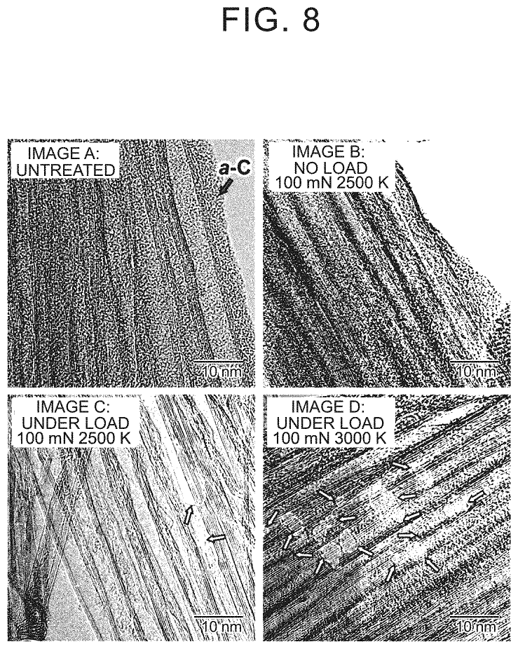

FIG. 8 shows images of the CNT spun yarns obtained in II-1 as observed with a transmission electron microscope. In the figure, image A is a transmission electron microscope image of the untreated control CNT spun yarn, image B is a transmission electron microscope image of the CNT spun yarn obtained by performing the spun yarn precursor β production step under no load and then performing electrical heating at 2500 K while applying a tension with a load of 100 mN (300 MPa to the spun yarn precursor β), image C is a transmission electron microscope image of the CNT spun yarn obtained by performing the spun yarn precursor β production step under load and then performing electrical heating at 2500 K while applying a tension with a load of 100 mN (300 MPa to the spun yarn precursor β), and image D is a transmission electron microscope image of the CNT spun yarn obtained by performing the spun yarn precursor β production step under load and then performing electrical heating at 3000 K while applying a tension with a load of 100 mN (300 MPa to the spun yarn precursor β). In the figure, the scale bar is 10 nm.

As shown in image A of FIG. 8, amorphous carbon (arrow a-C in image A) was observed in the untreated control CNT spun yarn. On the other hand, no amorphous carbon was observed in the CNT spun yarns obtained by performing the spun yarn precursor β production step under load or no load and then performing electrical heating while applying a tension (images B to D in FIG. 8). Flake-like crystal structures that indicate the presence of graphene were observed in the CNT spun yarns obtained by performing the spun yarn precursor β production step under load (arrows in images C and D in FIG. 8). This result suggests that graphene may be present in at least a part of the CNTs. Since more flake-like crystal structures were observed in the CNT spun yarn obtained by performing electrical heating at 3000 K, it is presumed that a structural change from amorphous carbon to graphene proceeded by the electrical heating at 3000 K.

### II-4. Strength Analysis of CNT Spun Yarns

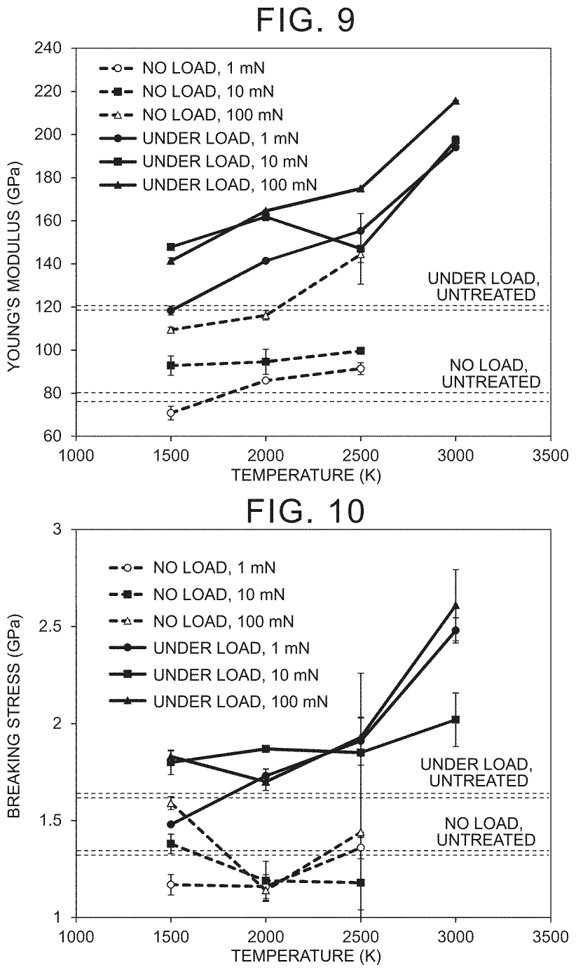

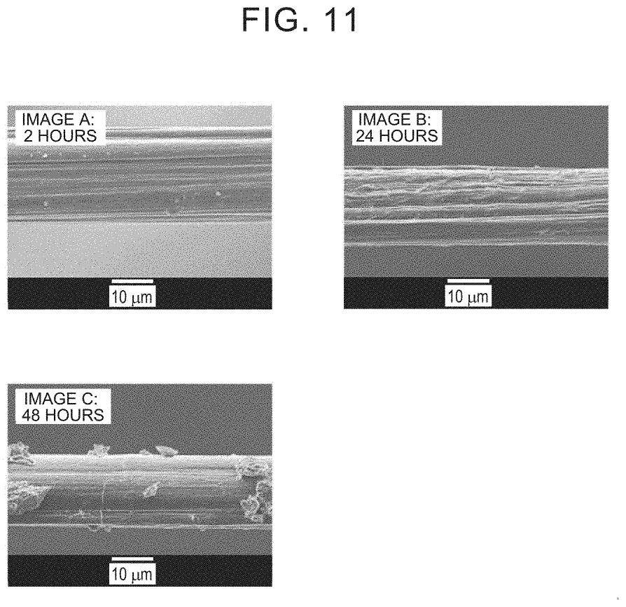

FIG. 9 shows the relationship between the electrical heating temperature in the spun yarn production step and the Young's modulus of the resultant CNT spun yarn for the spun yarns made of CNTs as obtained in II-1. FIG. 10 shows the relationship between the electrical heating temperature in the spun yarn production step and the breaking stress of the resultant CNT spun yarn for the spun yarns made of CNTs as obtained in II-1. In the figure, the abscissa represents the electrical heating temperature (K) in the spun yarn production step, and the ordinate represents the Young's modulus (GPa) or breaking stress (GPa) of the CNT spun yarn. The dashed lines in the figure indicate the Young's modulus or breaking stress of the untreated control CNT spun yarns obtained by performing the spun yarn precursor β production step under load or no load. The values in the figure indicate the average values and standard deviations of three test results.

As shown in FIG. 9, the Young's moduli of the CNT spun yarns obtained by performing the spun yarn precursor β production step under no load were substantially about the same as the Young's moduli of the untreated control CNT spun yarns. Even when the electrical heating temperature in the spun yarn production step was increased, no significant change in Young's modulus was observed for the resultant CNT spun yarns. On the other hand, the Young's moduli of the CNT spun yarns obtained by performing the spun yarn precursor β production step under load improved significantly as the electrical heating temperature in the spun yarn production step increased. In particular, the Young's moduli of the CNT spun yarns obtained by performing electrical heating at 3000 K were in the range of 190 GPa to 220 GPa.

As shown in FIG. 10, the breaking stresses of the CNT spun yarns obtained by performing the spun yarn precursor β production step under no load were substantially about the same as the breaking stresses of the untreated control CNT spun yarns. Even when the electrical heating temperature in the spun yarn production step was increased, no significant change in breaking stress was observed for the resultant CNT spun yarns. On the other hand, the breaking stresses of the CNT spun yarns obtained by performing the spun yarn precursor β production step under load improved significantly as the electrical heating temperature in the spun yarn production step increased. In particular, the breaking stresses of the CNT spun yarns obtained by performing electrical heating at 3000 K were in the range of 2.0 GPa to 2.8 GPa.

The results of the examples show that high strength CNT spun yarns can be obtained by performing the spun yarn precursor β production step while applying a high tension to the spun yarn precursor α under load and then performing electrical heating while applying a tension. Moreover, each of these obtained CNT spun yarns had an IG/ID of 5 or more in the Raman spectrum. This shows that graphene was present in at least a part of the CNTs in each of these obtained CNT spun yarns.

### III: Production of Spun Yarns Made of CNTs (2)

### III-1: Crosslinking Step

In the spun yarn precursor α production step, the spun yarn precursor α was produced by spinning a plurality of CNTs while applying a tension of 1 mN per centimeter of a width of the CNT forest. Then, in the spun yarn precursor β production step, the spun yarn precursor β was produced by spinning the spun yarn precursor α while applying a tension thereto with a load of 100 mN (300 MPa to the spun yarn precursor α). Thereafter, in the spun yarn production step, the CNT spun yarn was produced by removing residual oxygen, residual catalyst metal, and amorphous carbon through electrically heating the spun yarn precursor β at a temperature of 3000 K for one second with a distance between electrodes of 10 mm while applying a tension thereto with a load of 1 mN (3 MPa to the spun yarn precursor β).

Ultrapure water was produced by removing oxygen from pure water by nitrogen bubbling treatment for 30 minutes. Na₂S₄ powder (sulfidizing agent) was dissolved in the ultrapure water to prepare an aqueous solution containing 100 mmol/L (17.4 mg/mL) of Na₂S₄. The CNT spun yarn produced by the above procedure was impregnated with the aqueous solution containing Na₂S₄ for a specified time at 20° C., followed by natural drying at 20° C. for one day, to obtain CNT spun yarn in which the CNTs are crosslinked by disulfide bonds. As an untreated control, a CNT spun yarn obtained by only performing electrical heating in the spun yarn production step without performing the crosslinking step was used.

III-2: Surface Observation and Density Measurement of Crosslinked CNT Spun Yarns

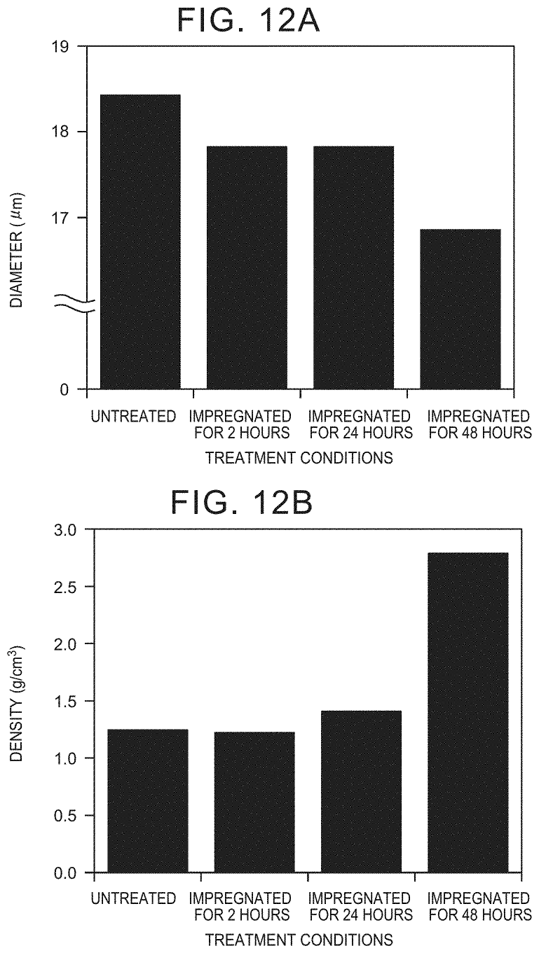

The surface of the CNT spun yarn obtained by the above procedure was observed with a scanning electron microscope. The obtained images are shown in FIG. 11. In the figure, image A is a scanning electron microscope image of the CNT spun yarn obtained by impregnation for two hours in the crosslinking step, image B is a scanning electron microscope image of the CNT spun yarn obtained by impregnation for 24 hours in the crosslinking step, and image C is a scanning electron microscope image of the CNT spun yarn obtained by impregnation for 48 hours in the crosslinking step. The scale bar in the figure is 10 μm. The diameter and the weight of the CNT spun yarn were measured and the density (bulk density) was calculated. FIGS. 12A and 12B show the diameters and the densities of the CNT spun yarns obtained under various treatment conditions. FIG. 12A is a graph showing the diameters of the CNT spun yarns, where the abscissa represents the impregnation time in the crosslinking step and the ordinate represents the diameter of the CNT spun yarn (μm). FIG. 12B is a graph showing the densities of the CNT spun yarns, where the abscissa represents the impregnation time in the crosslinking step and the ordinate represents the density of the CNT spun yarn (g/cm³).

As shown in FIGS. 11, 12A, and 12B, as the impregnation time in the crosslinking step increased, the diameter of the CNT spun yarn significantly decreased and the density of the CNT spun yarn significantly increased accordingly. For example, the diameter of the CNT spun yarn obtained by impregnation for 48 hours was 16.8 μm, whereas the diameter of the untreated control CNT spun yarn was 18.4 μm.

### III-3: Cross-Sectional Observation and Constituent Atom Analysis of Crosslinked CNT Spun Yarns

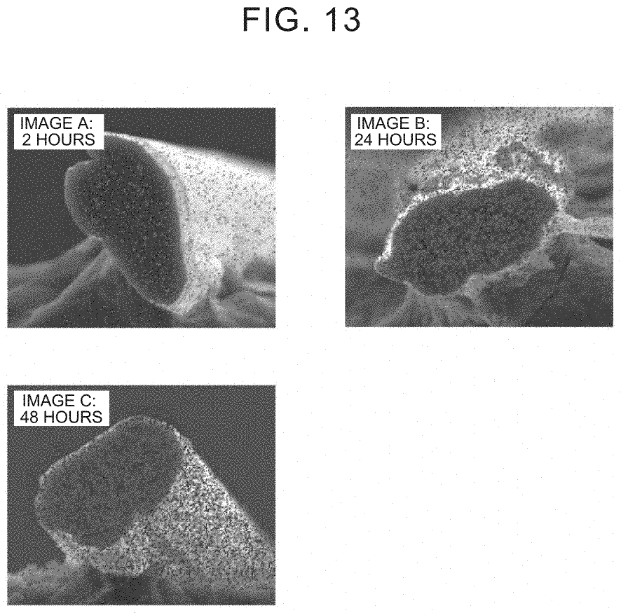

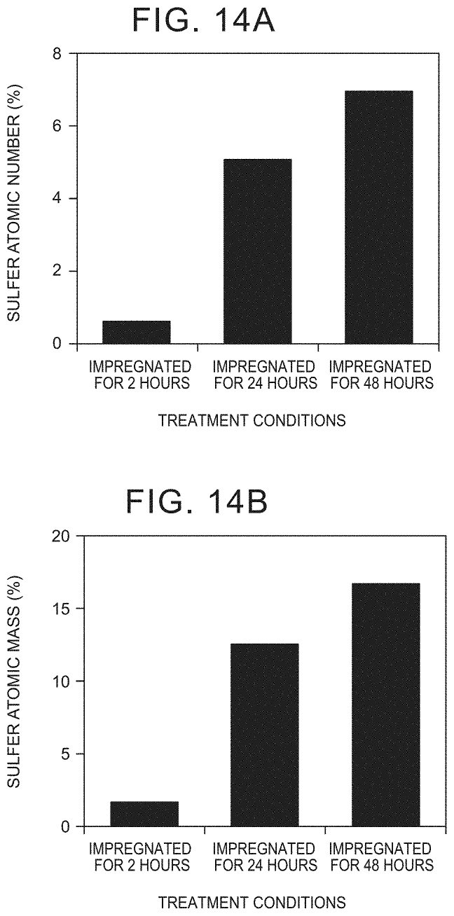

The CNT spun yarns obtained by the above procedure were cut with a focused ion beam (FIB). An energy dispersive X-ray spectrometry (EDS) was used to quantify the sulfur atoms present in the cross sections of the obtained CNT spun yarns. Scanning electron microscope images of the cross sections of the cut CNT spun yarns are shown in FIG. 13. In the figure, image A is a scanning electron microscope image of the CNT spun yarn obtained by impregnation for two hours in the crosslinking step, image B is a scanning electron microscope image of the CNT spun yarn obtained by impregnation for 24 hours in the crosslinking step, and image C is a scanning electron microscope image of the CNT spun yarn obtained by impregnation for 48 hours in the crosslinking step. The dots in the images show the sulfur atoms present in the cross sections of CNT spun yarns and mapped using the EDS. In addition, the results of quantification of the sulfur atoms present in the cross sections of the cut CNT spun yarns and quantified using the EDS are shown in FIGS. 14A and 14B. FIG. 14A is a graph showing percentages of the numbers of sulfur atoms relative to the total numbers of atoms present in the cross sections of the CNT spun yarns, where the abscissa represents the impregnation time in the crosslinking step and the ordinate represents the percentage (%) of the number of sulfur atoms. FIG. 14B is a graph showing percentages of the sulfur atomic mass relative to the total atomic mass present in the cross sections of the CNT spun yarns, where the abscissa represents the impregnation time in the crosslinking step and the ordinate represents the percentage (%) of the sulfur atomic mass.

As shown in FIGS. 13, 14A, and 14B, it was confirmed that sulfur atoms were introduced into the CNT spun yarns obtained by the method including the crosslinking step. The number and the mass of sulfur atoms introduced into the CNT spun yarns significantly increased as the impregnation time in the crosslinking step increased.

### III-4: Strength Analysis of Crosslinked CNT Spun Yarns

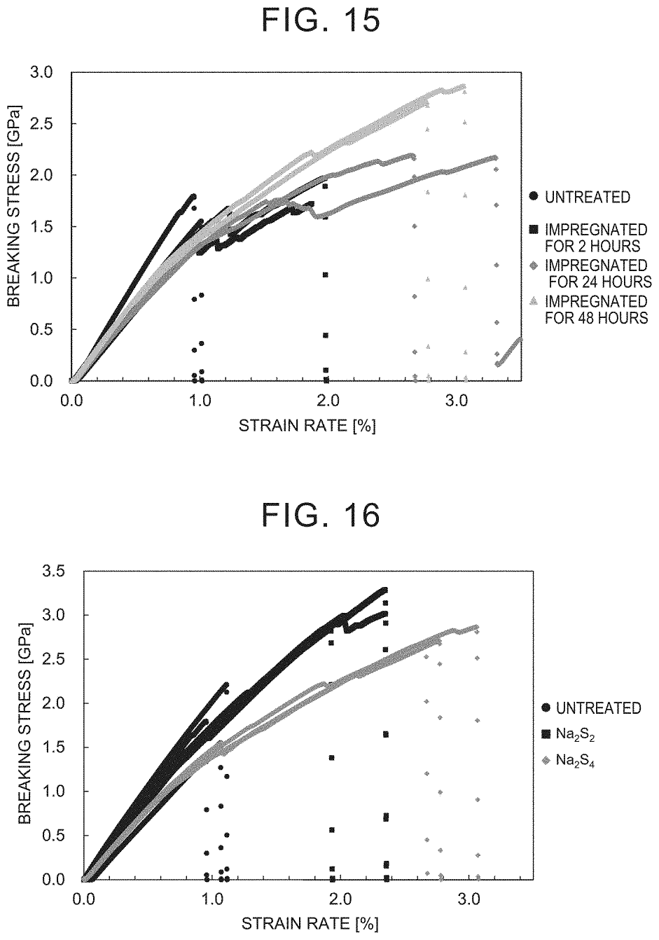

The breaking stresses of the CNT spun yarns obtained by the above procedure were measured based on ISO 11566:1996 (JIS R7606:2000) at a test speed of 1 mm/min and a distance between grips of 10 mm. FIG. 15 shows stress-strain curves of the CNT spun yarns obtained under various treatment conditions. In the figure, the abscissa represents the strain rate (%), and the ordinate represents the breaking stress (GPa) of the CNT spun yarn.

As shown in FIG. 15, the strain resistances and the breaking stresses of the CNT spun yarns obtained by the method including the crosslinking step were improved compared to the control CNT spun yarn. In particular, when the impregnation time in the crosslinking step was 48 hours, both strain resistance and breaking stress were significantly improved.

III-5: Strength Analysis of CNT Spun Yarns Crosslinked with Different Sulfurizing Agents

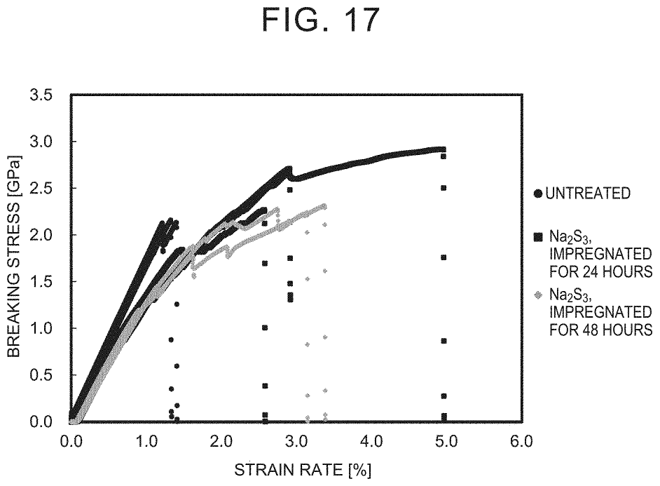

Crosslinked CNT spun yarns were obtained by the same procedure as described above, except that the sulfurizing agent used in the crosslinking step was changed to Na₂S₄, Na₂S₃, or Na₂S₂ and the impregnation time was changed to 48 hours or 24 hours. The breaking stresses of the obtained CNT spun yarns were measured based on ISO 11566:1996 (JIS R7606:2000) at a test speed of 1 mm/min and a distance between grips of 10 mm. FIGS. 16 and 17 show stress-strain curves of the CNT spun yarns obtained under various treatment conditions. In the figure, the abscissa represents the strain rate (%), and the ordinate represents the breaking stress (GPa) of the CNT spun yarn.

As shown in FIGS. 16 and 17, the strain resistance and the breaking stress of the CNT spun yarn obtained using each sulfurizing agent were significantly improved compared to the untreated control CNT spun yarn. The CNT spun yarn obtained by performing the crosslinking step using Na₂S₄ showed higher strain resistance than the CNT spun yarn obtained by performing the crosslinking step using Na₂S₂ (FIG. 16). The CNT spun yarn obtained by performing the crosslinking step using Na₂S₂ showed higher breaking stress than the CNT spun yarn obtained by performing the crosslinking step using Na₂S₄ (FIG. 16). The CNT spun yarn obtained by performing the crosslinking step using Na₂S₃ showed high breaking stress and higher strain resistance due to impregnation for 24 hours (FIG. 17). The CNT spun yarn obtained by performing the crosslinking step using Na₂S₃ showed higher strain resistance than the CNT spun yarn obtained by performing the crosslinking step using Na₂S₄ (FIGS. 16 and 17).

It is predicted by simulation that when the CNT spun yarn is treated with a sulfurizing agent, the CNTs are crosslinked by disulfide bonds and the like, and when a tensile force is applied to the crosslinked CNT spun yarn, the disulfide bonds recombine a number of times to improve the tensile strength (Composite Science and Technology, 2018, Vol. 166, pages 3 to 9). It was found, from the results of the present example, that by performing the crosslinking step, the CNTs constituting the CNT spun yarn are crosslinked by disulfide bonds, trisulfide bonds, or tetrasulfide bonds, so that voids decrease and the density of the CNT spun yarn increases. It was also found that the obtained CNT spun yarn has higher strength with significantly improved strain resistance and breaking stress compared to the case in which the crosslinking step was not performed.

The present disclosure is not limited to the above examples, and includes various modifications. For example, the above examples are described in detail for better understanding of the present disclosure, and the present disclosure is not necessarily limited to the CNT spun yarns having all the illustrated configurations. It is also possible to add other configuration(s), delete and/or replace a part of the configurations of each example.

What is claimed is:

1. A method for manufacturing a spun yarn made of carbon nanotubes, the method comprising:
a spun yarn precursor α production step of producing a spun yarn precursor α by pulling a plurality of carbon nanotubes from a carbon nanotube forest and spinning the carbon nanotubes while applying a tension of 6 mN or less per centimeter of a width of the carbon nanotube forest to the carbon nanotubes;
a spun yarn precursor β production step of producing a spun yarn precursor β by applying a higher tension than in the spun yarn precursor α production step to the spun yarn precursor α to densify the spun yarn precursor α; and
a spun yarn production step of producing the spun yarn by electrically heating the spun yarn precursor β while applying a tension to the spun yarn precursor β.

2. The method according to claim 1, wherein in the spun yarn precursor β production step, the tension is applied to the spun yarn precursor α while bringing the spun yarn precursor α into contact with a liquid selected from the group consisting of methanol, ethanol, acetone, water, paraffin and toluene, and mixtures of these substances.

3. The method according to claim 1, wherein in the spun yarn precursor β production step, the tension is applied stepwise to the spun yarn precursor α a plurality of times.

4. The method according to claim 1, wherein in the spun yarn production step, the electrical heating is performed at a temperature of 3200 K or less.

5. The method according to claim 1, wherein in the spun yarn production step, the electrical heating is performed while applying the tension of less than 480 MPa to the spun yarn precursor β.

6. The method according to claim 1, further comprising a crosslinking step of impregnating the spun yarn obtained in the spun yarn production step with an aqueous solution containing a salt of sulfide.

7. The method according to claim 6, wherein the salt of sulfide is sodium tetrasulfide or sodium disulfide.

8. A spun yarn made of carbon nanotubes, wherein in the spun yarn, a ratio of intensity of G band peak to intensity of D band peak in a spectrum obtained by Raman spectroscopy is 5 or more, and graphene is present in at least a part of the carbon nanotubes.

9. The spun yarn according to claim 8, wherein the carbon nanotubes are crosslinked by a disulfide bond, a trisulfide bond, or a tetrasulfide bond.
